(19) United States
(12) Patent Application Publication
(10) Pub. No.: US 2006/0087198 A1
(43) Pub. Date: Apr. 27, 2006

(54) Stator assembly for drum motor, a head drum assembly and a magnetic recording and reproducing apparatus

(75) Inventors: Tae-gil Kang, Suwon-si (KR); Myoung-joon Kim, Suwon-si (KR); Jeong-seon Kim, Suwon-si (KR); Young-ho Cho, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/254,701

(22) Filed: Oct. 21, 2005

(30) Foreign Application Priority Data
Oct. 22, 2004 (KR) 2004-84739

(51) Int. Cl. H02K 21/12; H02K 1/22

(52) U.S. Cl. 310/268; 310/DIG. 6; 310/156.32

(57) ABSTRACT

A stator assembly for a drum motor to generate a driving force in a motor rotor. A frequency printed circuit (FPC) is patterned with a plurality of main driving coils, and a yoke is connected to the FPC. The FPC may include a first substrate and a second substrate that are preferably attached by adhesive to each other. An upper side of the first substrate is patterned with the plurality of main driving coils. A frequency generation coil and a phase generation coil are patterned on the upper side of the first substrate to control driving velocity of the drum motor and a rotational position of the stator assembly, respectively. A cover layer may be attached to the upper side of the first substrate to shield the coils patterned on the first substrate. An upper side of the second substrate, which faces the first substrate, is patterned with sub driving coils. The sub driving coils are formed to substantially correspond to the main driving coil to enhance a driving force of the main driving coils. Therefore, the second substrate is configured in substantially the same manner as the first substrate. The sub driving coils are electrically connected with the main driving coils through a connection hole in the first and second substrates.

### CROSS-REFERENCE TO RELATED APPLICATIONS

This application claims the benefit under 35 U.S.C. § 119(a) of Korean Patent Application No. 2004-84739, filed Oct. 22, 2004, the entire contents of which are hereby incorporated by reference.

### BACKGROUND OF THE INVENTION

1. Field of the Invention

The present invention relates to a stator assembly for a drum motor, and a head drum assembly for a magnetic recording and reproducing apparatus having the same.

2. Description of the Related Art

Generally, a magnetic recording and reproducing apparatus records information on a recording medium, such as magnetic tape, and reproduces the recorded information. A video cassette tape recorder (VCR) and a camcorder are examples of magnetic recording and reproducing apparatuses.

The magnetic recording and reproducing apparatus includes a main deck, a head drum assembly rotatably mounted on the main deck to record and reproduce information with respect to a magnetic tape, and a tape guiding means for guiding running of the magnetic tape.

The head drum assembly is rotatably mounted and slanted by a predetermined angle with respect to the main deck to enhance the recording and reproducing functions. FIG. 1 shows an exemplary conventional head drum assembly.

Referring to FIG. 1, a static drum 11 is mounted on a shaft 10, and a rotary drum 12 is rotatably mounted to the shaft 10 adjacent the static drum 11. The rotary drum 12 supports a magnetic head 13 for recording and reproducing the information by scanning the running magnetic tape. At an upper part of the rotary drum 12, a drum cover 14 is fixed to the shaft 10. A rotary transfer 15 and a static transfer 16 are formed respectively on the rotary drum 12 and the drum cover 14, preferably, facing each other, to convert a magnetic signal to an electric signal.

A motor rotor 17 is mounted to the rotary drum 12 while a motor stator 18 is mounted to the static drum 11 to face the motor rotor 17. The motor rotor 17, being magnetic, generates a driving force for rotating the rotary drum 12 in cooperation with the motor stator 18.

A metal yoke 19 is mounted to a lower part of the motor stator 18. The static drum 11 is fixed separately from the motor stator 18 such that the yoke 19 focuses a magnetic force of the motor stator 18, thereby enhancing a current characteristic for rotating the rotary drum 12.

As shown in FIG. 2, the motor stator 18 includes a printed circuit board (PCB) 18a and a fine pattern (FP) coil 18b integrally formed within the PCB 18a. The motor stator 18 is formed by patterning nine coils for driving the motor on the PCB 18a. Additionally, a phase generation (PG) coil for controlling a location of the motor and a frequency generation (FG) coil for controlling a velocity of the motor are patterned on the PCB 18a. The motor stator 18 has a predetermined thickness and includes at one side a soldering terminal 18c to connect to a separate flexible printed circuit (FPC) by soldering.

However, a conventional motor stator as described above requires very complicated processes of patterning a plurality of coils, thereby increasing the fabricating cost.

Furthermore, since the soldering terminal 18c is connected to a separate FPC by soldering, the assembling process is complicated.

Additionally, the soldering connection may damage the coils patterned on the PCB 18a due to a high soldering temperature.

Accordingly, a need exists for a magnetic recording and reproducing apparatus having a drum that has an improved stator assembly.

### SUMMARY OF THE INVENTION

Accordingly, an aspect of the present invention is to provide a stator assembly for a drum motor that is stably assembled, and a head drum assembly for a magnetic recording and reproducing apparatus having the same.

A stator assembly for a drum motor generates a driving force proximal a motor rotor includes a flexible printed circuit (FPC) patterned with a plurality of main driving coils. A yoke is connected to the FPC.

The FPC is further patterned with a frequency generation (FG) coil for controlling a driving velocity of a motor and a phase generation (PG) coil for controlling a phase of the motor.

The main driving coils, the FG coil and the PG coil are substantially coplanar.

The FPC is integrally patterned with a plurality of signal lines for applying electric signals to the main driving coils, the FG coil and the PG coil.

The FPC is further provided with sub driving coils patterned at a predetermined distance from the main driving coils to correspond to the main driving coils.

The FPC includes a first substrate patterned with the main driving coils on one side thereof, and a second substrate layered on the other side of the first substrate and patterned with the sub driving coils.

The sub driving coils are patterned on the side facing the first substrate.

The first and the second substrates are attached to each other by an adhesive.

The first and the second substrates are made of copper plates.

The main driving coils and the sub driving coils are electrically connected. The first and the second substrates include a connection hole for the electric connection of the main driving coils and the sub driving coils.

The FPC further includes a cover layer attached to one side of the first substrate to shield the main driving coils. The cover layer is attached to the one side of the first substrate by an adhesive.

The FPC further includes a basal layer on which the second substrate is layered. The basal layer is attached by an adhesive to one side of the second substrate, which is the side not facing the first substrate.

The basal layer is made of a polymer film.

The yoke is attached to the basal layer by an adhesive.

The FPC includes a substantially annular stator part having the main driving coils and connected to the yoke. A connection part extends from one side of the stator part by a predetermined length and having a signal line electrically connected to the main driving coils.

Another aspect of the present invention may be achieved by providing a head drum assembly for a magnetic recording and reproducing apparatus including a static drum fixed to a shaft, a rotary drum rotatably mounted to the shaft in the face of the static drum and supporting a magnetic head, and a drum motor for driving the rotary drum. The drum motor includes a rotor mounted to the rotary drum, and a stator assembly mounted to the static drum facing the rotor and having main driving coils patterned on one side thereof and a yoke attached to the other side thereof.

The FPC is further patterned with a frequency generation (FG) coil for controlling a driving velocity of a motor and a phase generation (PG) coil for controlling a phase of the motor.

The main driving coils, the FG coil and the PG coil are preferably substantially coplanar.

The FPC is further provided with sub driving coils patterned at a predetermined distance from the main driving coils to correspond to the main driving coils.

The FPC includes a first substrate patterned with the main driving coils on one side thereof, and a second substrate attached on the other side of the first substrate and patterned with the sub driving coils. A cover layer is attached to one side of the first substrate, and a basal layer supports the second substrate.

The first and the second substrates include a connection hole for the electric connection of the main driving coils and the sub driving coils.

Yet another aspect of the present invention is achieved by providing a magnetic recording and reproducing apparatus for recording information on a magnetic tape and reproducing recorded information that includes a deck and a head drum assembly mounted to the deck. A rotary drum supports a magnetic head that records and reproduces information with respect to the tape and a static drum. A drum motor drives the rotary drum. The drum motor includes a rotor mounted to the static drum, and a stator assembly mounted to the static drum facing the rotor and having the FPC patterned with main driving coils on one side thereof and a yoke connected to the FPC.

Other objects, advantages and salient features of the invention will become apparent from the following detailed description, which, taken in conjunction with the annexed drawings, discloses preferred embodiments of the invention.

### BRIEF DESCRIPTION OF THE DRAWING FIGURES

The above aspects and other features of the present invention will become more apparent by describing in detail exemplary embodiments thereof with reference to the attached drawing figures, wherein;

FIG. 1 is an elevational view in cross section of a head drum assembly for a conventional magnetic recording and reproducing apparatus;

FIG. 2 is a perspective view showing a frequency generation (FG) coil of FIG. 1;

FIG. 3 is an elevational view in cross section of a magnetic recording and reproducing apparatus according to an exemplary embodiment of the present invention;

FIG. 4 is an elevational view in cross section of a stator assembly of FIG. 3;

FIG. 5 is an exploded, perspective view of the stator assembly of FIG. 3; and

FIG. 6 is an elevational view in cross section of the stator assembly of FIG. 5 assembled.

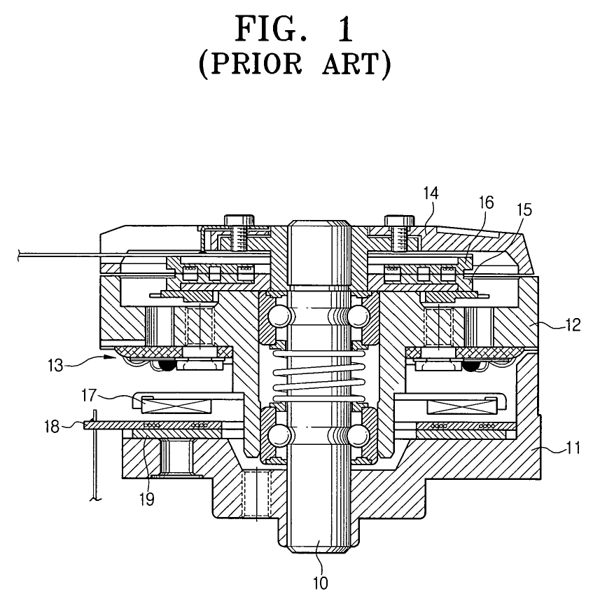

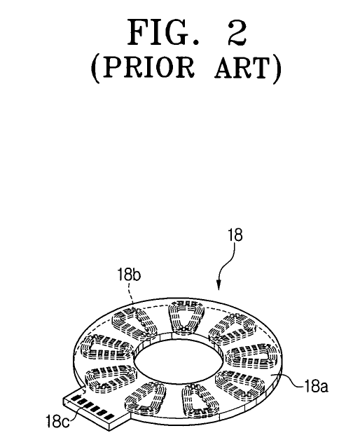

Throughout the drawings, like reference numerals will be understood to refer to like parts, components and structures.

### DETAILED DESCRIPTION OF EXEMPLARY EMBODIMENTS

Hereinafter, certain exemplary embodiments of the present invention are described in detail with reference to the accompanying drawing figures.

The matters defined in the description, such as a detailed construction and elements thereof, are provided to assist in a comprehensive understanding of the present invention. Thus, it is apparent that the present invention may be carried out without those defined matters. Also, well-known functions or constructions are omitted to provide a clear and concise description of exemplary embodiments of the present invention.

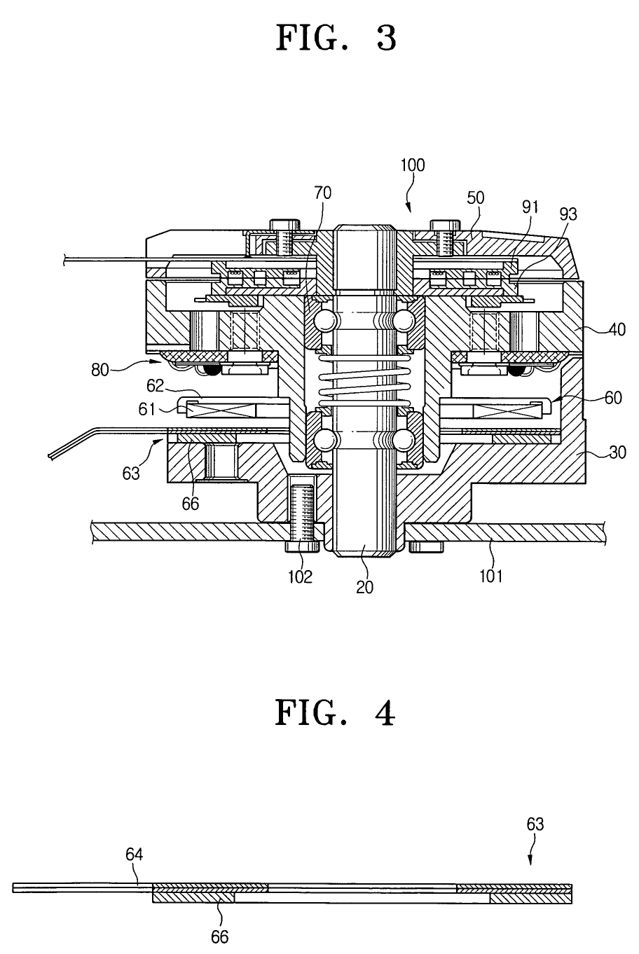

Referring to FIG. 3, a magnetic recording and reproducing apparatus according to an exemplary embodiment of the present invention includes a deck 101 and a head drum assembly 100 mounted on the deck 101. The deck 101 is mounted in a main body of the magnetic recording and reproducing apparatus, such as a camcorder, which is for recording and reproducing information with respect to a magnetic tape. The deck 101 includes thereon a running device for driving the magnetic tape, and a guide device. Since mechanism using the deck 101 is generally known in the art, a detailed description thereof is omitted.

The head drum assembly 100 includes a static drum 30 fixed to a shaft 20, a rotary drum 40 rotatably mounted to an upper part of the static drum 30, a drum cover 50 mounted to an upper part of the rotary drum 40, and a drum motor 60 for driving the rotary drum 40.

The static drum 30 is disposed on shaft 20. Also, the static drum 30 is fixed to the deck 101, being fastened thereto by a fastener, such as a screw 102.

The rotary drum 40 is engaged with the shaft 20 above the static drum 30 to face the static drum 30. A bearing 70 is disposed between the rotary drum 40 and the shaft 20.

A magnetic head 80 supported by the rotary drum 40 records information on a magnetic tape and reproduces recorded information by scanning the magnetic tape.

The drum cover 50 is disposed above the rotary drum 40 and disposed on the shaft 20. The drum cover 50 and the rotary drum 40 respectively include a static transfer 91 and a rotary transfer 93 for transmitting information read by the magnetic head 80.

The drum motor 60 includes a rotor 61 mounted to the rotary drum 40 and a stator assembly 63 mounted to the static drum 30.

The rotor 61 is preferably substantially annular and magnetic and mounted to the rotary drum 40 by a rotor case 62.

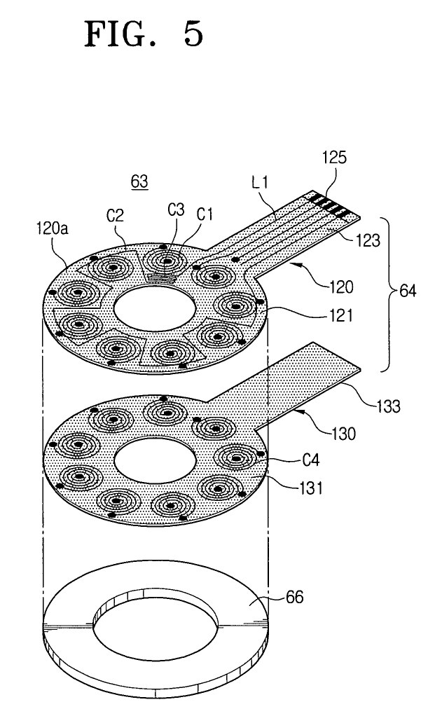

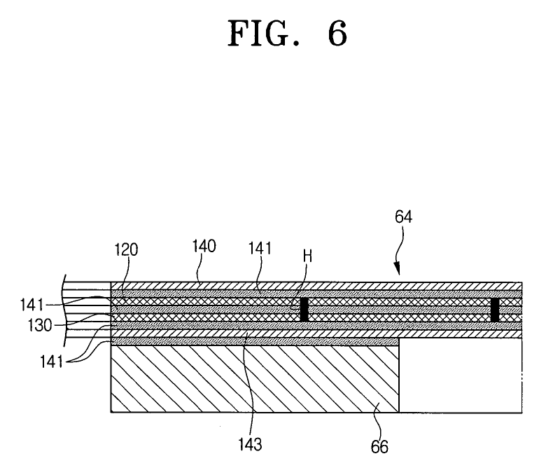

The stator assembly 63 is mounted to the static drum 30 at a predetermined distance from the rotor 61. As shown in FIGS. 4 to 6, the stator assembly 63 includes a flexible printed circuit (FPC) 64 and a yoke 66.

More specifically, the FPC 64 includes a couple of layered FPCs, that is, a first substrate 120 and a second substrate 130 that are attached by adhesive 141 to each other.

An upper side 120a of the first substrate 120 is patterned with a plurality of main driving coils C1 having a spiral form. The driving coils C1 are patterned on the upper side of the first substrate 120 through serial processes for fabricating a semiconductor. The first substrate 120 is preferably formed of a thin copper plate. A frequency generation (FG) coil C2 and a phase generation (PG) coil C3 are patterned on the upper side of the first substrate 120. The FG coil C2 controls a driving velocity of the drum motor 60, whereas the PG coil C3 controls a phase, that is, a rotational position of the stator assembly 63.

As described above, the driving coils C1, the FG coil C2 and the PG coil C3 are simultaneously patterned on the upper side of the first substrate 120. The respective coils C1, C2 and C3 are provided to a stator part 121, which has an annular form, of the first substrate 120. A connection part 123 extending from the stator part 121 is patterned with a plurality of signal lines L1. The signal lines L1 are simultaneously patterned and electrically connected with the coils C1 to C3 to apply electric signals to the respective coils C1 to C3. The connection part 123 has at an end thereof a connection land 125 for the signal lines L1 to be connected with a predetermined connector.

A cover layer 140 is attached to the upper side of the first substrate 120 by the adhesive 141 to shield the coils C1 to C3 patterned on the first substrate 120. The cover layer 140 may be a thin polymer film.

An upper side of the second substrate 130, which faces the first substrate 120, is patterned with sub driving coils C4. The sub driving coils C4 are formed to substantially correspond to the main driving coil C1 to enhance a driving force of the main driving coils C1. Therefore, the second substrate 130 is configured in substantially the same manner as the first substrate 120, where the sub driving coils C4 are radially arranged on an annular stator part 131. The sub driving coils C4 are electrically connected with the main driving coils C1. The first and the second substrates 120 and 130 have a connection hole H. The respective driving coils C1 and C4 may be electrically connected by filling the connection hole H with a conductive material, such as copper, during fabrication of the FPC 64.

The second substrate 130 is layered on a basal layer 143. The basal layer 143 is attached to a lower side of the second substrate 130 by the adhesive 141 to shield the second substrate 130. The basal layer 143 may be formed of a thin polymer film.

The yoke 66 is attached to a lower part of the basal layer 143 by the adhesive 141. The yoke 66 is preferably formed of metal and has a substantially annular form substantially corresponding to the stator parts 121 and 131.

As described above, the stator assembly 60 includes the FPC 64 and the yoke 66 attached by the adhesive as a single unit. The stator assembly 60 is assembled as a unit and engaged with the static drum 30.

In the above-structured stator assembly 60, the FPC 64 includes the stator parts 121 and 131 having the coils C1 to C4, and the connection parts 123 and 133. Therefore, a dedicated process, such as welding, for connecting the coils C1 to C4 to the signal lines L1 or the connection lands 125 exposed to the outside is not necessitated. As a result, damage to the coils, which may be caused by heat from the welding process, may be prevented.

Furthermore, by using the FPC instead of a printed circuit board (PCB), which is more expensive than the FPC, the fabrication cost may be reduced. Also, productivity is improved by simplifying the assembling processes.

As may be appreciated from the above description of the magnetic recording and reproducing apparatus according to an exemplary embodiment of the present invention, the stator assembly for the drum motor is formed by assembling the FPC having the driving coils, the FG coil and the PG coil as patterned thereon and the yoke. Therefore, mounting of the stator assembly to the drum is easy. Also, a dedicated process, such as welding, for the electric connection is not required. Consequently, component parts may be prevented from being damaged by the electric connection, thereby improving reliability and stability of the products.

While the invention has been shown and described with reference to certain embodiments thereof, it will be understood by those skilled in the art that various changes in form and details may be made therein without departing from the spirit and scope of the invention as defined by the appended claims.

What is claimed is:

1. A stator assembly for a drum motor, for generating a driving force in the face of a motor rotor, comprising:
a flexible printed circuit (FPC) patterned with a plurality of main driving coils; and
a yoke connected to the FPC.

2. The stator assembly of claim 1, wherein
the FPC has a frequency generation (FG) coil to control a driving velocity of a motor and a phase generation (PG) coil to control a phase of the motor.

3. The stator assembly of claim 2, wherein
the main driving coils, the FG coil and the PG coil are substantially coplanar.

4. The stator assembly of claim 2, wherein
the FPC is integrally patterned with a plurality of signal lines for applying electric signals to the main driving coils, the FG coil and the PG coil.

5. The stator assembly of claim 1, wherein
the FPC has a plurality of sub driving coils patterned at a predetermined distance from the plurality of main driving coils to substantially correspond to the plurality of main driving coils.

6. The stator assembly of claim 5, wherein the FPC includes
a first substrate patterned with the plurality of main driving coils on one side thereof, and
a second substrate layered on the other side of the first substrate and patterned with the plurality of sub driving coils.

7. The stator assembly of claim 6, wherein
the plurality of sub driving coils are patterned on the side facing the first substrate.

8. The stator assembly of claim 6, wherein
the first and second substrates are attached to each other by an adhesive.

9. The stator assembly of claim 6, wherein
the first and second substrates are made of copper plates.

10. The stator assembly of claim 6, wherein
the plurality of main driving coils and the plurality of sub driving coils are electrically connected.

11. The stator assembly of claim 10, wherein
the first and second substrates include a connection hole to electrically connect the plurality of main driving coils and the plurality of sub driving coils.

12. The stator assembly of claim 6, wherein the FPC includes
a cover layer attached to the one side of the first substrate to shield the plurality of main driving coils.

13. The stator assembly of claim 12, wherein
the cover layer is attached to the one side of the first substrate by an adhesive.

14. The stator assembly of claim 6, wherein
the FPC includes a basal layer on which the second substrate is layered.

15. The stator assembly of claim 14, wherein
the basal layer is attached by an adhesive to one side of the second substrate that is not facing the first substrate.

16. The stator assembly of claim 14, wherein
the basal layer is made of a polymer film.

17. The stator assembly of claim 14, wherein
the yoke is attached to the basal layer by an adhesive.

18. The stator assembly of claim 1, wherein the FPC includes
a substantially annular stator part having the plurality of main driving coils, and the stator part is connected to the yoke; and
a connection part extended from one side of the stator part by a predetermined length and having a signal line electrically connected to the main driving coils.

19. A head drum assembly for a magnetic recording and reproducing apparatus, comprising:
a static drum fixed to a shaft;
a rotary drum rotatably mounted to the shaft facing the static drum and supporting a magnetic head; and
a drum motor for driving the rotary drum, the drum motor including
a rotor mounted to the rotary drum, and
a stator assembly mounted to the static drum proximal the rotor and having a plurality of main driving coils patterned on one side thereof and a yoke attached to the other side thereof.

20. The head drum assembly of claim 19, wherein
the stator assembly has a frequency generation (FG) coil for controlling a driving velocity of a motor and a phase generation (PG) coil for controlling a phase of the motor.

21. The head drum assembly of claim 20, wherein
the plurality of main driving coils, the FG coil and the PG coil are substantially coplanar.

22. The head drum assembly of claim 19, wherein
the stator assembly has a plurality of sub driving coils patterned at a predetermined distance from the main driving coils substantially corresponding to the plurality of main driving coils.

23. The head drum assembly of claim 22, wherein
a first substrate is patterned with the plurality of main driving coils on one side thereof;
a second substrate is attached on the other side of the first substrate and patterned with the plurality of sub driving coils;
a cover layer is attached to the one side of the first substrate; and
a basal layer supports the second substrate.

24. The head drum assembly of claim 23, wherein
the first and the second substrates have a connection hole to electrically connect the plurality of main driving coils and the plurality of sub driving coils.

25. A magnetic recording and reproducing apparatus for recording information to a magnetic tape and reproducing recorded information thereon, comprising:
a deck;
a head drum assembly mounted to the deck and having a rotary drum for supporting a magnetic head that records and reproduces information with respect to the tape and a static drum; and
a drum motor for driving the rotary drum, the drum motor including
a rotor mounted to the static drum, and
a stator assembly mounted to the rotary drum proximal the rotor and having a FPC patterned with a plurality of main driving coils on one side thereof and a yoke connected thereto.

26. The head drum assembly of claim 25, wherein
the FPC is patterned with a frequency generation (FG) coil for controlling a driving velocity of a motor and a phase generation (PG) coil for controlling a phase of the motor.

27. The head drum assembly of claim 26, wherein the FPC includes
a first substrate is patterned with the plurality of main driving coils, the FG coil and the PG coil on one side thereof; and
a second substrate is attached on the other side of the first substrate and patterned with a plurality of sub driving coils substantially corresponding to the main driving coils.

28. The head drum assembly of claim 27, wherein the FPC includes
a cover layer is attached to one side of the first substrate to shield the one side; and
a basal layer supports the second substrate and is connected to the yoke.

29. The head drum assembly of claim 27, wherein
the first and the second substrates have a connection hole to electrically connect the plurality of main driving coils and the plurality of sub driving coils.

30. The head drum assembly claim 26, wherein the FPC includes
a stator part has a substantially annular form and is patterned with the plurality of main driving coils, the FG coil and the PG coil on one side and is connected to the yoke on the other side; and
a connection part extends from the stator part by a predetermined length and has a signal line for applying electric signals to the plurality of main driving coils, the PG coil and the FG coil.
